(19) United States
(12) Patent Application Publication
(10) Pub. No.: US 2007/0216125 A1
(43) Pub. Date: Sep. 20, 2007

(54) Steering System

(75) Inventor: John Baxter, Chatswood (AU)

Correspondence Address: BIRCH STEWART KOLASCH & BIRCH, PO BOX 747, FALLS CHURCH, VA, 22040-0747, US

(73) Assignee: Bishop Innovation Limited, North Ryde, NSW (AU)

(21) Appl. No.: 10/580,174

(22) PCT Filed: Dec. 2, 2004
(86) PCT No.: PCT/AU04/01681

§ 371 Date: Apr. 23, 2007

(30) Foreign Application Priority Data
Dec. 2, 2003 (AU) 2003906676

(51) Int. Cl. B62D 3/12

(52) U.S. Cl. 280/93.514

(57) ABSTRACT

A rack and pinion steering gear for a vehicle comprising a housing (2), a pinion (1) rotatable about a first axis (14) in the housing, a rack (7) laterally displaceable with respect to the housing, and an intermediate gear (8) interposed between, and meshing with, the pinion (1) and with the rack (7), the intermediate gear (8) rotatable about a second axis (9). The second axis (9) is laterally movable with respect to the housing as a function of at least one vehicle parameter, by an actuator mechanism, thereby varying the relationship between the angular displacement of the pinion and the lateral displacement of the rack as a function of the vehicle parameter.

### TECHNICAL FIELD

The present invention relates to a rack and pinion steering gear for a vehicle and in particular to a means of actively varying the rack gain and also the steering offset angle between the on-centre position of the steering wheel and the on-centre position of the road wheels.

### BACKGROUND

Recently there has been interest in superposition steering systems where a supplementary steering input can be made to the steering angle of the front road wheels by a superposition device which is receiving inputs from sensed parameters, typically including the steering wheel angle input from the driver and the vehicle speed, this resulting in an output at the rack and pinion steering gear tie-rods which is effectively the sum of the steering wheel angle input from the driver and the input from the superposition device.

A large number of these systems use a planetary gear box to impart an additional angular displacement to the pinion, as described in U.S. Pat. No. 3,831,701 (Pilon et al.). Other systems, such as the device described in International Patent Publication WO 02/36410 (Bishop), achieve the supplementary steering input by allowing the pinion to move substantially laterally in the direction of the rack travel. Thus incremental steering angle outputs at the road wheels can be generated, even for substantially zero steering wheel angle input by the driver, and this incremental output can used to neutralise the effect of external yaw and lateral position disturbances on the vehicle caused by crosswinds and road chamber. These systems also typically enable the “rack gain” of the rack and pinion steering system to be varied as a function of other sensed parameters such as vehicle speed.

In the automotive industry “rack gain” of a rack and pinion steering gear is defined as the instantaneous linear displacement of the rack per unit of angular displacement of the input shaft. Rack gain is normally expressed in the units “mm/rev”, however it is important to realize that rack gain is an instantaneously measured quantity. Racks having constant rack gain are known as “constant ratio racks”. Such constant ratio racks have a constant rack tooth pitch. However a significant portion of racks used in the automotive industry have a variable tooth pitch and are termed “variable ratio racks”. The corresponding rack and pinion arrangement in the latter case normally has a variable rack gain measured as a function of input shaft angle from the on-centre position.

Both the above mentioned superposition systems therefore enable the modulation of rack displacement output at the tie rods (and hence the steering angle of the steerable road wheels) independent of the input shaft angle (and hence the driver's steering wheel angle input) and also, by definition, the modulation of the rack gain of the rack and pinion system.

However planetary arrangements, such as described in U.S. Pat. No. 3,831,701, are inherently complex mechanisms. Most of these arrangements, for example that incorporated in the ZFLS AFS system (an optional feature in the BMW E60), involve the use of 6-8 additional planetary gears and an additional ring gear in the steering system “drive train”. Transmission of the steering rotation through such multiple sets of meshing gears renders such steering gear systems not only expensive, but also prone to high friction levels and gear backlash.

Moreover, the other earlier mentioned arrangements which are based on substantially lateral displacement of the pinion, such as described in WO 02/36410, involve the need for very accurate longitudinal or rotational journaling of the pinion in order to avoid backlash in the rack and pinion steering system. Such journal systems tend to be therefore complex and expensive. Also, since the pinion rotational axis is displaced laterally in the steering gear housing during normal steering operation, means must be provided to transmit the steering rotational input from the input shaft to the laterally displaceable pinion, and yet maintain a seal between the housing and the input shaft which provides this rotational input. Some arrangements simply allow the input shaft to laterally displace and effectively “follow” the pinion. However this introduces substantial complexities not only in sealing this translational interface but also in the practical packaging of the hydraulic connections to the power steering valve (in the case of hydraulic power assisted steering gears) or the electrical connections to the torque sensor (in the case of electric power assisted steering gears). Other more preferred arrangements fix the axis of the input shaft in the steering gear housing, hence avoiding the aforementioned sealing and packaging problems, and transmit the steering rotational input to the pinion by an Oldham coupling or portion of a planetary gear set. However these arrangements are also potentially prone to gear meshing friction or backlash, or a combination thereof, and this is in addition to the complexity of the journaling arrangement earlier referred to.

U.S. Pat. No. 3,908,479 (MacDuff) describes a rack and pinion steering gear with an intermediate gear interposed between, and meshing with, the pinion and the rack. An axis fixed in this intermediate gear is laterally constrained by a linkage or pin-and-slot arrangement so that substantially no lateral displacement (ie. in the direction of the rack travel) of this axis occurs as the pinion, and hence the intermediate gear, rotates. This axis is arranged eccentrically relative to the central axis of the intermediate gear, and hence the central axis of the intermediate gear moves laterally as it rotates, effectively “adding” or “subtracting” displacement to the rack, and hence generating a variable rack gain. However this relationship is completely determined by the geometry of the linkage or pin-and-slot arrangement and the diameter of the intermediate gear, and hence is a “fixed relationship” characterised by a varying rack gain as a function of steering angle input applied at the input shaft. In fact this fixed relationship will repeat for each 360 deg rotation of the intermediate gear and, for this reason, the intermediate gear is arranged so its pitch circumference is approximately equal to the overall lock-to-lock rack travel. In practical terms, this means that the pitch diameter of the intermediate gear is typically 3-4 times larger than that of the pinion.

U.S. Pat. No. 6,467,365 (Jorg et al.) also shows a rack and pinion steering gear with an intermediate gear interposed between, and meshing with, the pinion and the rack. In this case the intermediate gear is journalled in the steering gear housing at its central axis and therefore, again, cannot displace laterally relative to the housing. In the case of this prior art patent, the intermediate gear serves the purposes of, firstly, increasing the distance between the pinion axis of rotation and rack longitudinal axis (henceforth termed the “box-centre” distance) and, secondly, it effectively reverses the direction of rack displacement for a given steering angle input applied at the input shaft of the steering gear (and hence also at the pinion). It is argued in this prior art patent that this arrangement is advantageous in terms of packaging of rack and pinion steering gears in particular front chassis arrangements. Since the intermediate gear is journalled in the steering gear housing at its central axis, it is not possible to vary the relationship between the angular displacement of the pinion and the lateral displacement of the rack. Hence the arrangement generates a fixed rack gain if the rack is constant ratio.

German Patent 3327979 (Novak et al.) also shows a rack and pinion steering gear with an intermediate gear interposed between, and meshing with, the pinion and the rack. In this case the intermediate gear is eccentrically journalled in the steering gear housing and hence this axis, about which the intermediate gear rotates, cannot displace laterally relative to the housing. In the case of this prior art patent, the intermediate gear is arranged to mesh with a similarly eccentrically journalled pinion and this is used to create a variable rack gain in the steering gear. Similar to the earlier mentioned steering gear of U.S. Pat. No. 3,908,479, this relationship is completely determined by the gear geometry, and hence this is a “fixed relationship” characterised by a varying rack gain as a function of steering angle input applied at the input shaft. Again also, this fixed relationship will repeat for each 360 deg rotation of the intermediate gear and, for this same reason stated earlier, the intermediate gear needs to be arranged so it pitch circumference is many times larger than that of the pinion.

The object of the present invention is to provide a steering gear for a vehicle that ameliorates at least some of the problems of the prior art.

### SUMMARY OF INVENTION

The present invention consists of a rack and pinion steering gear for a vehicle, the steering gear comprising a housing, a pinion rotatable about a first axis in the housing, a rack laterally displaceable with respect to the housing, an intermediate gear interposed between, and meshing with, the pinion and with the rack, the intermediate gear rotatable about a second axis, characterised in that the second axis is laterally movable with respect to the housing as a function of at least one vehicle parameter, by an actuator mechanism, thereby varying the relationship between the angular displacement of the pinion and the lateral displacement of the rack as a function of the vehicle parameter.

Preferably, the second axis is eccentric with respect to the central axis of the intermediate gear. Alternatively, the second axis is also the central axis of the intermediate gear.

Preferably, the actuator mechanism comprises a linkage, the linkage maintaining a fixed distance between the second axis and a third axis when the axial load exerted on the linkage is less than a predefined value.

Preferably, the third axis is fixed with respect to a crank and offset from its axis of rotation, thereby arcuately translating the third axis on rotation of the crank and displacing the actuator mechanism.

Preferably, the axis of rotation of the crank is fixed with respect to the housing.

Preferably, rotation of the crank is effected by a servomotor.

Preferably, the linkage incorporates an overload mechanism which causes a shortening or lengthening of the distance between the second and third axes when the axial load exerted on the linkage exceeds the predefined value.

Preferably, the third axis is defined by the rotational centre of a journal bearing, needle roller bearing or ball bearing connecting the linkage to the crank.

Preferably, the second axis is defined by the rotational centre of a journal bearing, needle roller bearing or ball bearing connecting the intermediate gear to the linkage.

Preferably, the relationship comprises varying the rack gain, and the parameter is the steering wheel angle or the speed of the vehicle.

Preferably, the relationship comprises the generation of an additional lateral displacement of the rack, and the parameter is the magnitude of side load applied to the vehicle due to cross wind disturbances or road camber.

Preferably, the intermediate gear comprises two subgears relatively angularly displaceable about the central axis of the intermediate gear and urged by a spring preloading mechanism to minimize mesh backlash between the intermediate gear and the pinion, and between the intermediate gear and the rack.

### BRIEF DESCRIPTION OF DRAWINGS

FIG. 1 shows an isometric view the steering gear according to a first embodiment of the present invention, with the housing cover removed to show the front of the actuator mechanism,

FIG. 2 is the same isometric view of the steering gear as shown in FIG. 1, with part of the housing removed to reveal more of the actuator mechanism,

FIG. 3 is a lateral sectional elevation of the steering gear in FIG. 1,

FIG. 4 is the same isometric view of the steering gear as shown in FIG. 1, with the housing removed,

FIG. 5 is a plan view of the steering gear in FIG. 1, with the housing removed,

FIG. 6 is an end elevation of the steering gear in FIG. 1, with the housing removed,

FIG. 7 is a lateral sectional elevation of the steering gear in FIG. 1 along the rack longitudinal axis, with the housing removed and the intermediate gear shown in the “on-centre” position,

FIG. 8 is a lateral sectional elevation of the steering gear in FIG. 1 along the rack longitudinal axis, with the housing removed and the intermediate gear shown displaced away from the “on-centre” position,

FIG. 9 shows possible relationships between angular displacement of the pinion and lateral displacement of the rack, for the steering gear shown in FIG. 1,

FIG. 10 is a lateral sectional elevation of a steering gear along the rack longitudinal axis according to a second embodiment of the present invention, with the housing removed and the intermediate gear shown in the “on-centre” position, and

FIG. 11 shows possible relationships between angular displacement of the pinion and lateral displacement of the rack, for the steering gear shown in FIG. 10.

### BEST MODE OF CARRYING OUT THE INVENTION

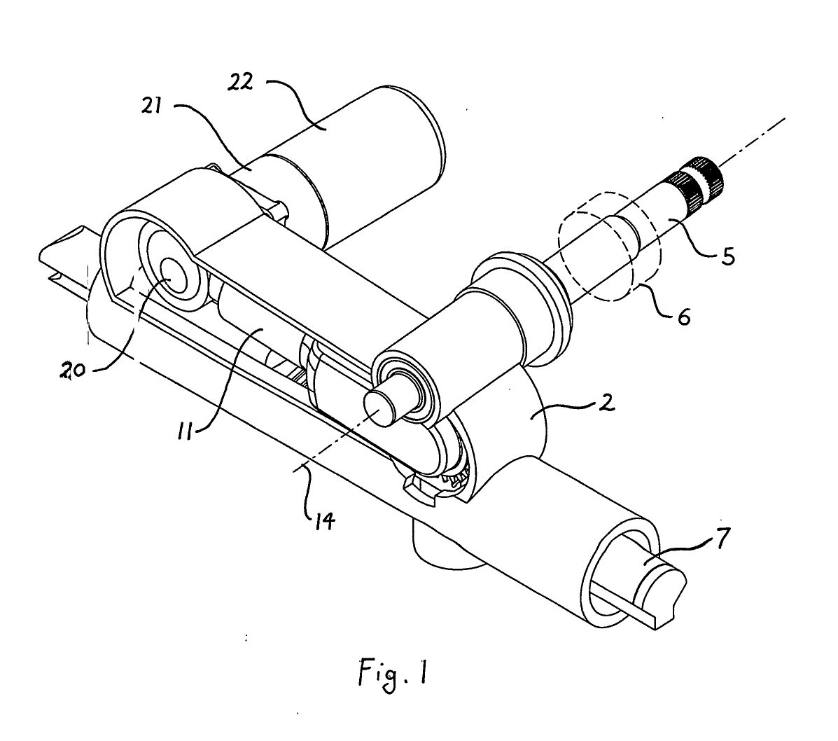

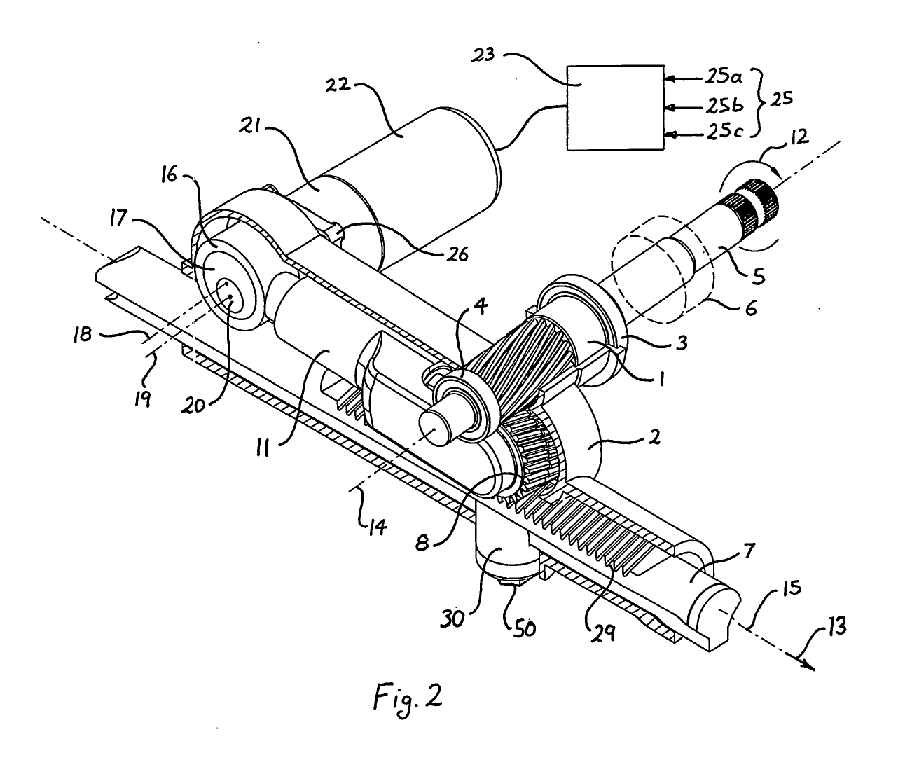

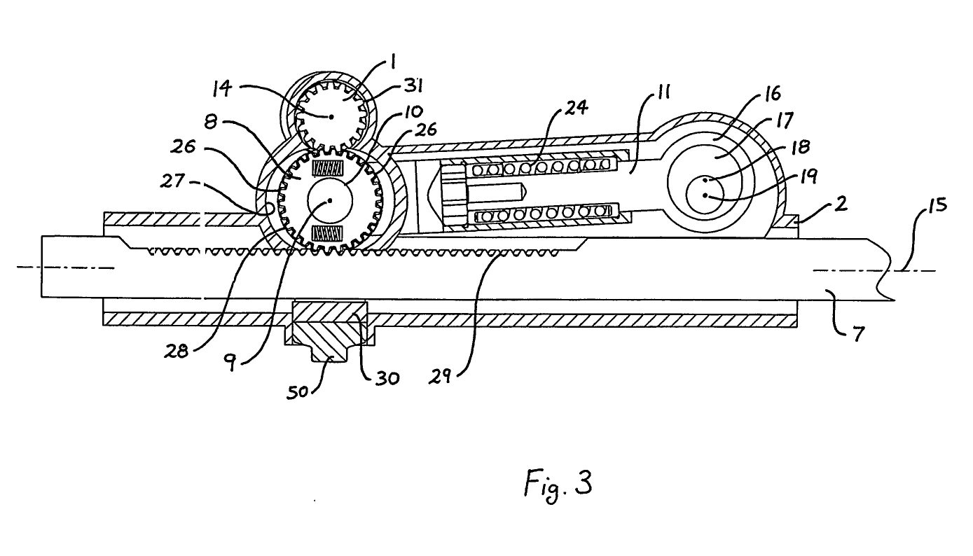

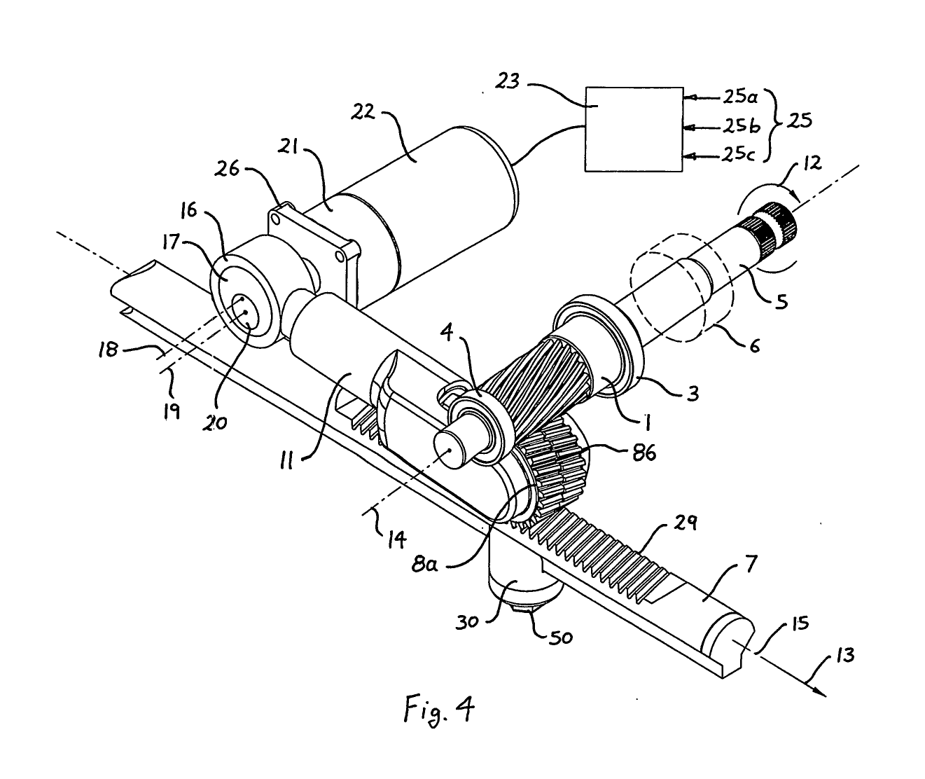

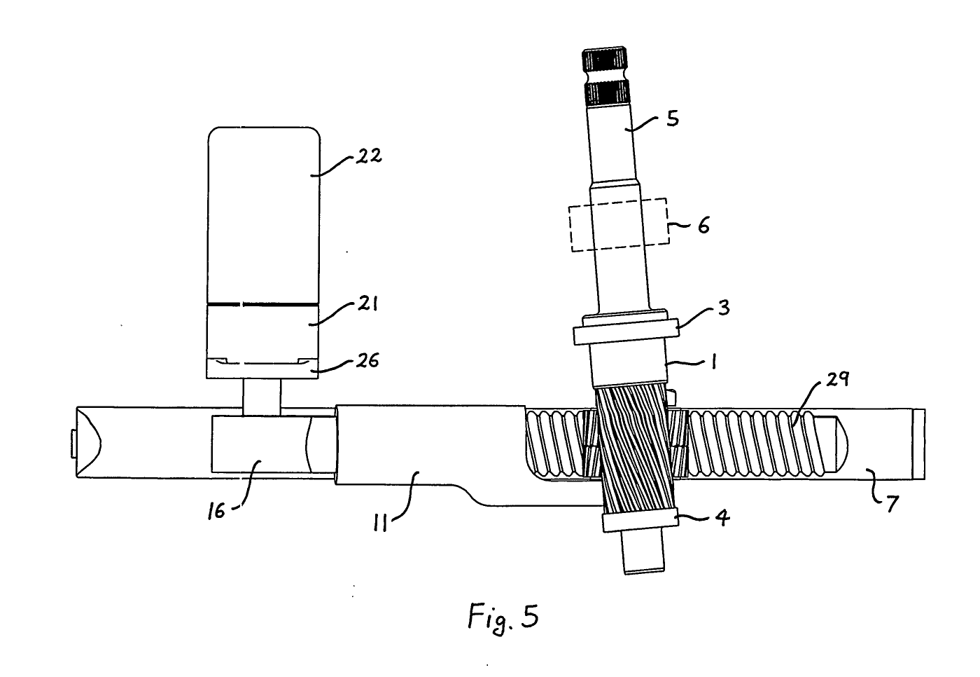

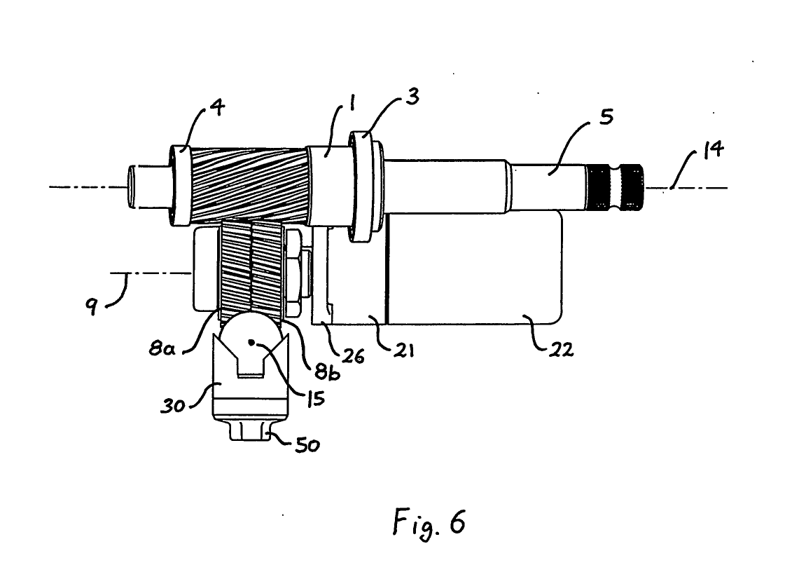

FIGS. 1-6 show the rack and pinion steering gear according to a first embodiment of the present invention. This steering gear comprises pinion 1 rotatable in housing 2 about axis 14 as result of the journaling provided-by upper bearing 3 and lower bearing 4. Input shaft 5 provides the steering wheel angle input from the driver and, in a manual (non power assisted) rack and pinion steering gear, is connected to or is integral with pinion 1. In hydraulic power assisted steering (HPAS) or electric power assisted steering (EPAS) input shaft 5 is usually connected to pinion 1 by a torsion bar and a small relative rotation occurs between these two components as a function of the input torque applied by the driver to input-shaft 5. This relative rotation is detected by a rotary valve (in an HPAS system) or a torque sensor 6 (in an EPAS system, shown dotted) and these control the power assistance provided to the rack and pinion steering gear. In this patent specification, the method of operation of the power assistance is not relevant. Hence, for clarity of explanation, pinion 1 and input shaft 5 are shown as being directly connected as they would be in a manual rack and pinion steering gear.

The rack and pinion steering gear also comprises rack 7 laterally displaceable in housing 2 in the direction of its longitudinal axis 15 via one or more axial journal bearings (not shown). Intermediate gear 8 is interposed between and meshes simultaneously with rack 7 and pinion 1. Intermediate gear 8 is rotatable about axis 9, as a result of its journaling on shaft 10 of linkage 11. This journaling is shown as a plain journal bearing in this embodiment of the present invention. However, in certain applications, friction can be reduced by preferably employing a needle roller bearing or a ball bearing at the rotational interface between shaft 10 and intermediate gear 8.

Anticlockwise angular displacement 12 of input shaft 5 (as viewed from the driver), and hence of pinion 1, causes a clockwise rotation of intermediate gear 8 and therefore a lateral displacement 13 of rack 7. This relationship between angular displacement 12 and lateral displacement 13 is opposite to that for a conventional rack and pinion steering gear in which pinion 1 meshes directly with rack 7. Also, the offset distance between axis 14 of pinion 1 and longitudinal axis 15 of rack 7 (termed the “box-centre distance” according to industry practice) is obviously larger than that for a convention rack and pinion steering gear due to the incorporation of interposed intermediate gear 8. However it can be easily shown that, providing that shaft 10 of linkage 11 is not moving laterally relative to housing 2, and that axis 9 is also the central axis of intermediate gear 8, incorporation of intermediate gear 8 does not in fact change of rack gain of the rack and pinion steering gear—that is compared to the rack gain of the corresponding conventional rack and pinion steering gear where the same pinion 1 meshes with the same rack 7. All that occurs is the direction of lateral displacement 13 of rack 7 is reversed. This reversal of motion and the above mentioned larger box-centre distance provided by incorporation of intermediate gear 8 is an advantage for many steering and chassis layouts in modem cars, as earlier referred to in reference to the prior art.

Linkage 11 comprises sleeve 16 at its end remote from shaft 10, and this is journalled with respect to crank 17 about axis 18. Axis 18 is eccentrically located with respect to axis of rotation 19 of crank 17, the latter fixed to output shaft 20 of gearbox 21. Gearbox 21 is secured to housing 2 of the rack and pinion steering gear via mounting flange 26 and its input shaft (not shown) is driven by servo motor 22 under control of servo controller 23. Rotation of output shaft 20, and hence crank 17 about axis of rotation 19, is significantly geared down with respect to rotation of servo motor 22. For example, if a 30:1 gear ratio was employed, 30 deg of rotation of servo motor 22 would correspond to 1 deg of rotation of crank 17 about axis of rotation 19. The gearing is arranged to be sufficiently inefficient that that torques applied to output shaft 20 by linkage 11 cannot “reverse drive” servo motor 22. It should be noted that the journaling between crank 17 and sleeve 16 is shown as a plain journal bearing in this embodiment of the present invention. However, in certain applications, friction can be selectively reduced by preferably employing a needle roller bearing or a ball bearing at the rotational interface between these components.

Linkage 11 also incorporates an overload mechanism in the form of doubly-trapped spring assembly 24. Spring assembly 24 is, according to conventional engineering practice for this class of overload mechanism, internally preloaded to a predetermined maximum load L (typically 2.5 kN). In this manner linkage 11 maintains its axial rigidity providing the axial load in the linkage is less than predetermined maximum load L. Hence, under these circumstances, linkage 11 maintains a fixed distance between axis 9 of shaft 10 and axis 18 of sleeve 16. Rotation of crank 17, under the influence of servo motor 22, results in arcuate translation of axis 18 of sleeve 16, and hence substantially laterally displacement of linkage 11. This in turn causes lateral moving of shaft 10 which provides the journal for rotation of intermediate gear 8 about axis 9.

Servo controller 23 is provided with at least one vehicle parameter 25 as an input, and the magnitude of this at least one parameter 25 is processed by servo controller 23 to determine, and hence closed-loop control, the angular position of servo motor 22 and, in turn, generate lateral movement of axis 9 of intermediate gear 8 with respect to housing 2.

In this specification the actuator mechanism for generating this lateral movement of axis 9 comprises servo motor 22, gearbox 21, sleeve 16, crank 17, and linkage 11 (and various other subcomponents, some shown and some not shown). However it should be realized that many other classes of actuator mechanism could equally be used according to the particular application. For example, instead of using gearbox 21 and crank 17 to convert rotation of servo motor 22 to substantially lateral displacement of linkage 11, rotation of servo motor 22 could be directly converted to lateral displacement of linkage 11 via a linear recirculating ball nut arrangement. Alteratively lateral displacement of linkage 11 could be generated by a hydraulic cylinder/piston arrangement, the flow to which is controlled by an electrohydraulic servo valve (eg. as manufactured by Moog). In an HPAS system, the flow from the hydraulic steering pump could be used to service this electrohydraulic valve by placing this valve in the main HPAS hyrdraulic circuit either upstream or downstream of the aforementioned rotary valve.

Under steering impact conditions, typically occurring when a the steerable road wheel of a vehicle hits the curb or traverses a pot hole in the road, very high lateral loads (up to typically 25 kN) can be applied to rack 7 in the direction of its longitudinal axis 15. This, in turn, would potentially cause very high axial loads to be fed back through linkage 11 of the actuation mechanism which, if not dissipated at some point in the mechanism, would strip the teeth of the gears in gearbox 21 and/or bend its output shaft 20. For example, for the embodiment shown in FIGS. 1-6 in which axis 9 corresponds to the central axis of intermediate gear 8, a lateral load of 25 kN applied via the steering system tie rods (not shown) to rack 7 would result in an axial load of approximately 50 kN in linkage 11 (ie. double the rack load). Since this load is greater than the aforementioned predetermined maximum load L (typically 2.5 kN as mentioned earlier), the preload in spring assembly 24 is exceeded and linkage 11 axially deflects causing a shortening or lengthening of the distance between axis 9 of shaft 10 and axis 18 of sleeve 16. This limits the axial load in linkage 11 to the range +/−L (ie. L in compression ranging to L in tension) irrespective of lateral load applied to rack 7 in these steering impact conditions. The excess in the load beyond the range +/−L is dissipated by axis 9 of intermediate gear 8 laterally shifting to a “full-scale” position where lateral periphery 26 of the outside diameter of intermediate gear 8 contacts internal shoe portions 27 of housing 2. This has the effect of dissipating these very high lateral impact loads in rack 7 directly to housing 2 via intermediate gear 8. The relatively large pitch diameter of intermediate gear 8 (typically 40 mm) ensures a high contact ratio between the meshing teeth 28 of intermediate gear 8 and teeth 29 of rack 7, thereby ensuring that neither sets of teeth plastically deform or fail during this impact condition. Also the correspondingly relatively large outside diameter of intermediate gear 8 ensures a large contact area between the lateral periphery 26 of this outside diameter and internal shoe portions 27 of housing 2.

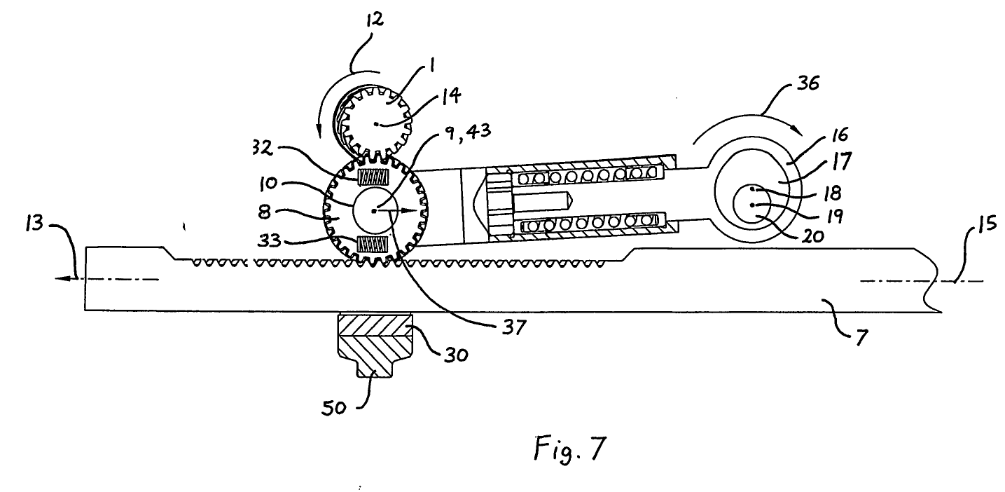

The box-centre distance between axis 14 of pinion 1 and longitudinal axis 15 of rack 7 is fine-tuned at the time of assembly of the rack and pinion steering gear. This is achieved by positioning rack 7 and intermediate gear 8 in the on-centre position in which the line connecting axis 14 of pinion 1 and axis 9 of intermediate gear 8 is perpendicular to longitudinal axis 15 of rack 7. This on-centre position for the various components in the rack and pinion steering gear is shown in FIG. 7. At this on-centre position, rack yoke 30 is adjusted upwardly (in FIG. 7) via “torqueing up” yoke nut 50 to “sandwich” intermediate gear 8 between rack 7 and pinion 1. Yoke nut 50 is then “backed-off” by a predetermined angle so only a small amount of box centre clearance is preset between pinion 1 and rack 7, typically 100-150 um. Such an adjustment method is the same as used today for conventional prior art rack and pinion steering gears. In this conventional arrangement yoke 30 would also normally comprise a yoke spring to preload longitudinal axis 15 of rack 7 towards axis 14 of pinion 1 with a preload force of typically 250-500 N. If used in a rack and pinion steering gear according to this embodiment of the present invention, this rack yoke preload arrangement using a rack yoke spring-would have the effect of preloading teeth 28 of intermediate gear 8 into mesh with teeth 29 of rack 7 and also preloading teeth 28 of intermediate gear 8 into mesh with teeth 31 of pinion 1.

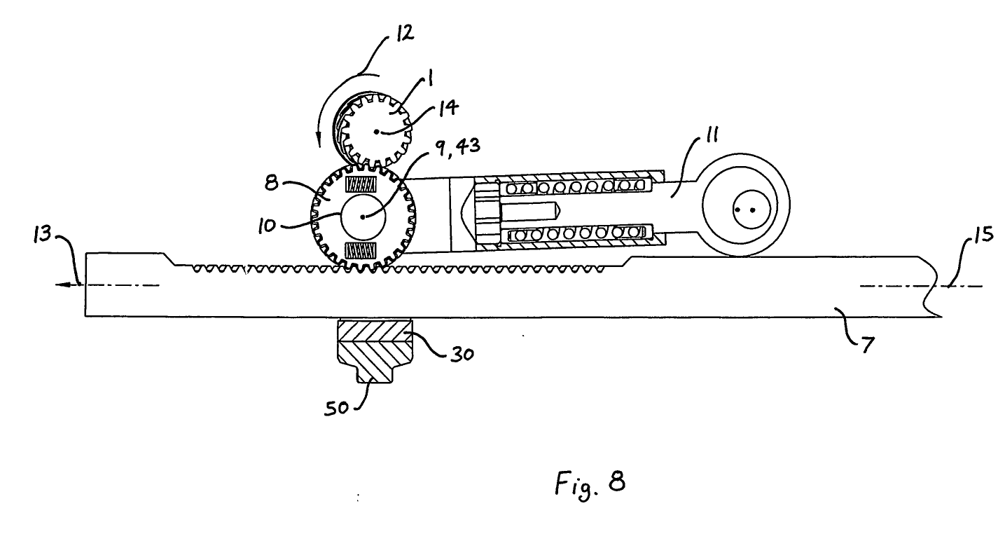

Such an arrangement, employing a conventional rack yoke spring, can be used according to the present invention, however it is not preferred. This reason it is not preferred is that lateral movement of axis 9 of intermediate gear 8 away from the on-centre position, under the action of the actuation mechanism, causes the line connecting axis 14 of pinion 1 to axis 9 of intermediate gear 8 to no longer be perpendicular to longitudinal axis 15 of rack 7. As shown in FIG. 8, this causes the “operating” box-centre clearance to effectively increase to a value much higher than that preset in the on-centre position (ie. the typical 100-150 um value) at the time of assembly of the rack and pinion steering gear.

For this reason it is preferred, according to the present invention, that intermediate gear 8 comprises two subgears 8a & 8b, relatively angularly displaceable about their central axis (axis 9 in the case of this first embodiment of the present invention), and angularly urged by springs 32 and 33 such that teeth 28a of subgear 8a and teeth 28b of subgear 8b angularly “separate” and minimize the backlash between teeth 28 of intermediate gear 8 and teeth 31 of pinion 1, and between teeth 28 of intermediate gear 8 and teeth 29 of rack 7. This spring preloading mechanism is arranged to have sufficient preset spring load that backlash-free meshing is achieved, irrespective of the laterally displaced position of axis 9 of intermediate gear 8, up to at least the aforementioned predetermined maximum load L (typically 2.5 kN) resisted by linkage 11.

In many applications, the use of such a spring preloading mechanism in intermediate gear 8, according to the present invention, removes the need for a rack yoke spring. However in certain less preferred embodiments of the present invention, both a spring preloading mechanism of intermediate gear 8 and a rack yoke spring in yoke 30 can be incorporated (not shown).

In this embodiment two springs 32 and 33 are shown in reference to the spring preloading mechanism, however it should be understood that any number of springs can be incorporated according to the packaging requirements of the particular steering gear application. Also intermediate gear 8 and pinion 1 are shown in this embodiment as helical gears. However in certain applications, for reasons of reducing cost, one of these gears (or, in the extreme case, may be both) can be designed as spur gears. The basic trade-off is the need to maintain a satisfactory contact ratio, and hence smoothness of mesh and tooth strength in the presence of the aforementioned impact loads, in the region where teeth 31 of pinion 1 mesh with teeth 26 of intermediate gear 8 and in the region where teeth of intermediate gear 8 mesh with teeth 29 of rack 7.

A rack and pinion steering system according to the present invention enables superposition of the steering wheel input provided by the driver and the input provided by an actuator mechanism, the actuator mechanism in the case of this embodiment comprising linkage 11. By arranging the control of servo motor 22 by servo controller 23 as a function of at least one vehicle parameter 25, the modulation of lateral displacement 13 of rack 7 (and hence the steering angle of the steerable road wheels) can be made independent of angular displacement 12 of pinion 1 (and hence the driver's steering wheel angle input applied to input shaft 5). This in turn enables independent modulation of the rack gain, and also independent modulation of the steering offset angle between the on-centre position of the steering wheel and the on-centre position of the road wheels.

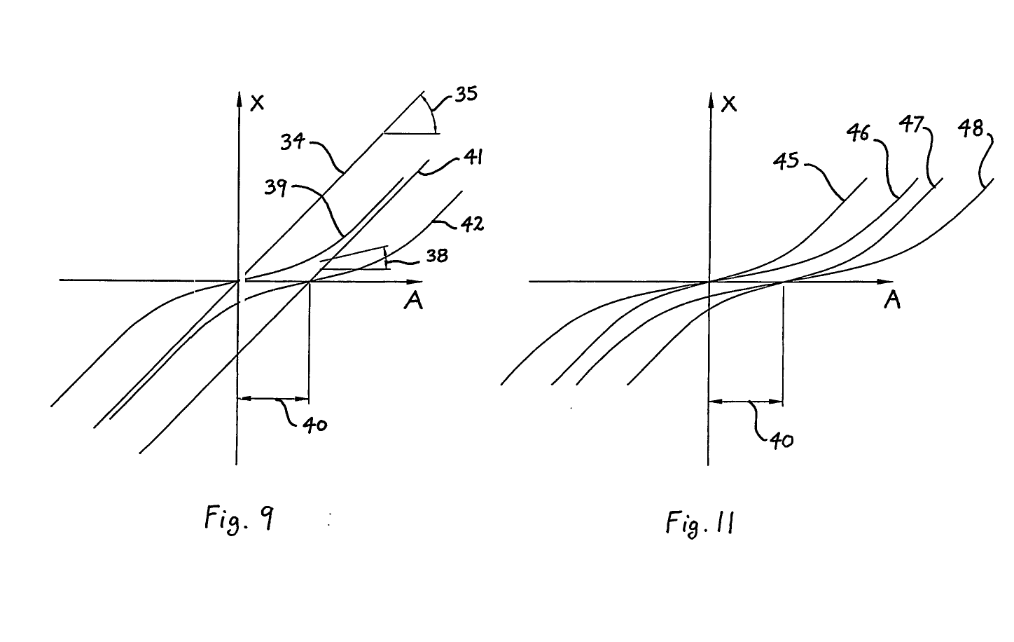

The manner in which these two steering parameters can be varied according to this embodiment of the present invention is now described graphically in reference to FIG. 9, where axis A is pinion angular displacement and axis X is rack lateral displacement. The plot in FIG. 9 corresponds to the embodiment of the present invention shown in FIGS. 7 and 8 in which axis 9 is also the central axis of intermediate gear 8. Also motor controller 23 is controlled by at least two vehicle parameters 25, comprising vehicle speed 25a and steering wheel angle 25b. Rack 7 is assumed to be a constant ratio rack in this forthcoming description.

Line 34 shows the typical constant rack gain relationship, corresponding to gradient 35 of line 34, achieved when axis 9 is the on-centre position (ie. as shown in FIG. 7) and not laterally moving with respect to housing 2. Such a relationship, in which a relatively high rack gain (high gradient of line 34) is utilized in the on-centre region of the steering gear, is typically employed at lower vehicle speeds to increase maneuverability and reduce tuns of the steering wheel.

Now, as vehicle speed 25a increases, servo motor controller 23 commands servo motor 22 to move axis 9 as a function of steering wheel angle 25b. For anticlockwise angular displacement 12 of input shaft 5 (and hence pinion 1) in the on-centre region, output shaft 20 of gear box 21 executes clockwise angular displacement 36 which imparts rightward lateral displacement 37 to axis 9 (refer to FIG. 7). This lateral movement of axis 9 subtracts from what would otherwise (normally) be a leftwards lateral displacement 13 of rack 7 for an anticlockwise angular displacement 12 of input shaft 5 (ie. if axis 9 did not move laterally). Hence the resulting lateral displacement 13 of rack 7 is reduced for a given angular displacement 12 of input shaft 5 in the on-centre region, thereby modulating the steering gear to generate a lower value of rack gain (gradient 38) in the on-centre region and hence generating a new nonlinear relationship (line 39) between the angular displacement 12 of input shaft 5 (and hence of pinion 1) and lateral displacement 13 of rack 7. This new relationship indicated by line 39 is used at higher vehicle speeds in order to reduce the yaw rate response, and hence the “twitchiness”, of the vehicle during high speed on-centre freeway driving.

However it is also possible that servo controller 23 commands servo motor 22 to laterally move axis 9, even for no corresponding angular displacement 12 of input shaft 5 (and hence pinion 1). A third possible vehicle parameter, the magnitude of the side load 25c applied to the vehicle due to cross wind disturbances or road camber, can be used as an additional input to servo controller 23 in this case. In this situation, the steering offset angle 40 between the on-centre position of the steering wheel and the on-centre position of the road wheels can be varied as a function of side load 25c applied to the vehicle, this latter vehicle parameter measured by computing the incremental value of the yaw rate at any instant of time which cannot be attributed to steering angle inputs by the driver (other methods of calculation are also possible).

The result is, that lines 34 and 39 are shifted to the right (or left) by the demanded value of steering offset angle 40, resulting in new relationships corresponding to lines 41 and 42 respectively. The effect of the inclusion of steering offset angle 40 in this relationship is that lateral displacement of rack 7 (and hence of the steerable road wheels of the vehicle) can be generated for no corresponding angular displacement of pinion 1 (and hence for no steering wheel input by the driver at input shaft 5). By selection of suitable software in servo controller 23, this arrangement can be designed to counteract (or at least dampen) the yaw and lateral position disturbances on the vehicle when the vehicle is driven under the influence of the above mentioned side load disturbances. This can be achieved actively and essentially “transparently” as far as the driver is concerned.

Essentially an arbitrary family of both linear and nonlinear relationships between angular displacement of input shaft 5 (and hence pinion 1) and lateral displacement of rack 7, and hence of rack gain variation and steering offset angle, can be generated as a function of the three vehicle parameters of steering wheel angle, vehicle speed and vehicle side load according to this embodiment of the present invention. These relationships are exampled in the case of this embodiment by the relationships represented by discrete lines 34, 39, 41 and 42. However it is important to realise that rack gain and steering offset angle are really only “Instantaneous events” rather than being represented by the fixed graphical relationships represented by lines 34, 39, 41 and 42. In fact the extent to which the relationship between angular displacement 12 of input shaft 5 (and hence of pinion 1) and the lateral displacement 13 of rack 7 is only limited by the magnitude of the maximum possible lateral movement of axis 9.

It is also important to appreciate that lateral displacement of axis 9 is applied by the actuation mechanism actively (ie. in real time, dynamically). The magnitude of the command signal for this lateral displacement is driven by vehicle dynamics algorithms programmed into servo controller 23 and, in reality, many more vehicle parameters than the three mentioned in this description of the present invention, can be used as inputs. For example, in most modern vehicle employing Electronic Stability Programs (ESP), vehicle lateral acceleration, yaw rate, roll angle, and longitudinal acceleration, lateral side slip, etc. are also measured by sensors at various parts of the chassis.

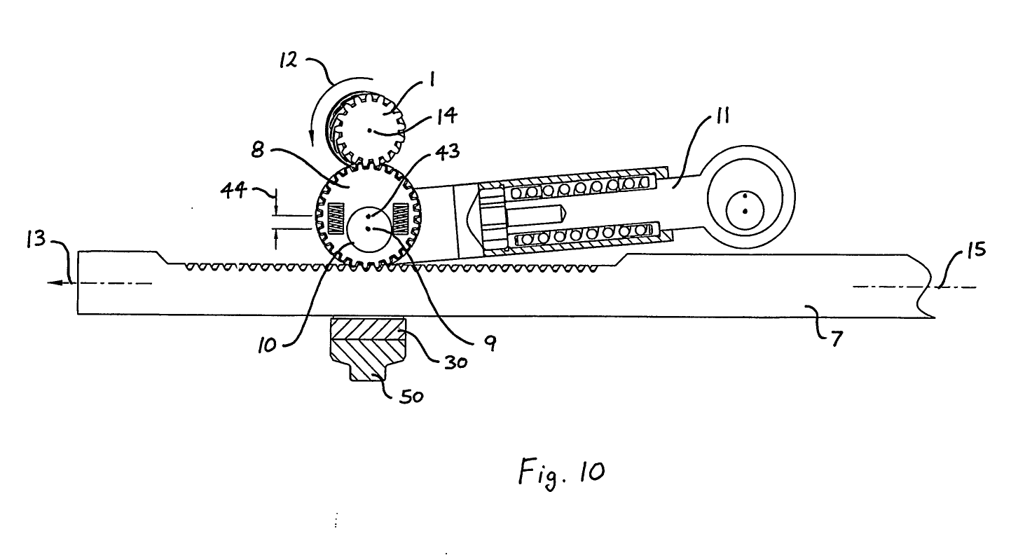

FIG. 10 shows a second embodiment of the present invention in which axis 9, corresponding to the axis on which shaft 10 and intermediate gear 8 are journalled, is eccentric by a distance 44 with respect to central axis 43 of intermediate gear 8. The effect of this is to convert the standard constant gain relationship, represented by line 34 in FIG. 9, to a non constant gain relationship as a function of angular displacement of pinion 1, represented by line 45 in FIG. 11—even for no lateral movement of axis 9. If all other parameters are left the same and axis 9 is laterally moved in the same way and as a function of the same vehicle parameters as in the case of the first embodiment of the present invention, line 34 now becomes line 45, line 39 becomes line 46, line 41 becomes line 47 and line 42 becomes line 48. This concept to achieve a “fixed” variation in rack gain as a function of angular pinion displacement (ie. the relationship shown as line 45), has already been described in reference to U.S. Pat. No. 3,908,479 and will not be described further in the present specification. In principle it can be used to generate a non constant gain relationship (eg. line 45), which could be employed at low vehicle speeds, on top of which any lateral movement of axis 9 can “build” at higher vehicle speeds, as driven by servo motor 22 under control of servo controller 23.

Another way to achieve such a “fixed” variation of rack gain as a function of angular pinion displacement is the use of a variable ratio rack (ie. a rack with a non-constant tooth pitch) according to concepts also well known in the art of steering gears over the last 20 years (not shown). Such a variable ratio rack could be designed to mesh with a helical or spur version of intermediate gear 8, however the scope for this concept to achieve large variation in rack gain is limited due to the relative large pitch diameter of intermediate gear 8. Nevertheless, in principle at least, the use of such a variable ratio rack in a steering gear according to the present invention could potentially be used to produced a family of curves similar to that shown in FIG. 11.

Although the present invention has been described in various embodiments in this specification, it is recognised that departures may be made form the embodiments without departing from the scope of the invention.

The term “comprising” as used in this specification is used in the inclusive sense of “including” or “having”, and not in the exclusive sense of “consisting only of”.

1. A rack and pinion steering gear for a vehicle, the steering gear comprising a housing, a pinion rotatable about a first axis in the housing, a rack laterally displaceable with respect to the housing, an intermediate gear interposed between, and meshing with, the pinion and with the rack, the intermediate gear rotatable about a second axis, characterised in that the second axis is laterally movable with respect to the housing as a function of at least one vehicle parameter, by an actuator mechanism, thereby varying the relationship between the angular displacement of the pinion and the lateral displacement of the rack as a function of the vehicle parameter.

2. A rack and pinion steering gear as claimed in claim 1 wherein the second axis is eccentric with respect to the central axis of the intermediate gear.

3. A rack and pinion steering gear as claimed in claim 1 wherein the second axis is also the central axis of the intermediate gear.

4. A rack and pinion steering gear as claimed in claim 1 wherein the actuator mechanism comprises a linkage, the linkage maintaining a fixed distance between the second axis and a third axis when the axial load exerted on the linkage is less than a predefined value.

5. A rack and pinion steering gear as claimed in claim 4 wherein the third axis is fixed with respect to a crank and offset from its axis of rotation, thereby arcuately translating the third axis on rotation of the crank and displacing the actuator mechanism.

6. A rack and pinion steering gear as claimed in claim 5 wherein the axis of rotation of the crank is fixed with respect to the housing.

7. A rack and pinion steering gear as claimed in claim 5 wherein rotation of the crank is effected by a servomotor.

8. A rack and pinion steering gear as claimed in claim 4 wherein the linkage incorporates an overload mechanism which causes a shortening or lengthening of the distance between the second and third axes when the axial load exerted on the linkage exceeds the predefined value.

9. A rack and pinion steering gear as claimed in claim 4 wherein the third axis is defined by the rotational centre of a journal bearing, needle roller bearing or ball bearing connecting the linkage to the crank.

10. A rack and pinion steering gear as claimed in claim 1 wherein the second axis is defined by the rotational centre of a journal bearing, needle roller bearing or ball bearing connecting the intermediate gear to the linkage.

11. A rack and pinion steering gear as claimed in claim 1 wherein the relationship comprises varying the rack gain, and the parameter is the steering wheel angle or the speed of the vehicle.

12. A rack and pinion steering gear as claimed in claim 1 wherein the relationship comprises the generation of an additional lateral displacement of the rack, and the parameter is the magnitude of side load applied to the vehicle due to cross wind disturbances or road camber.

13. A rack and pinion steering gear as claimed in claim 1 wherein the intermediate gear comprises two subgears relatively angularly displaceable about the central axis of the intermediate gear and urged by a spring preloading mechanism to minimize mesh backlash between the intermediate gear and the pinion, and between the intermediate gear and the rack.
